(19) United States
(12) Patent Application Publication
(10) Pub. No.: US 2002/0035608 A1
(43) Pub. Date: Mar. 21, 2002

(54) Automated follow-up to a request

(76) Inventor: Rajko Milovanovic, Plano, TX (US)

Correspondence Address: TEXAS INSTRUMENTS INCORPORATED, P O BOX 655474, M/S 3999, DALLAS, TX, 75265

(21) Appl. No.: 09/925,903

(22) Filed: Aug. 9, 2001

Related U.S. Application Data
(60) Provisional application No. 60/223,980, filed on Aug. 9, 2000.

(51) Int. Cl. G06F 15/16

(52) U.S. Cl. 709/206

(57) ABSTRACT

An automated follow-up system is described wherein when composing a message request a deadline is also set and requests the recipient respond by a deadline date.

### FIELD OF THE INVENTION

This invention relates to electronic message systems such as desktop e-mail and, more particularly, to an automated follow-up.

### BACKGROUND OF THE INVENTION

Many people, including practically managers of people, send each day a number of messages using electronic communication systems (shortly, systems—for example, cellular phone or set-top-box e-mail, or desktop e-mail or voicemail) which are generically a request (“passing a ball”)—by sender to receiver(s), for receiver(s) to carry out an action. For example tasks facility of Microsoft Outlook (TM). See U.S. Pat. No. 5,923,848 of Goodhand et al. entitled “System and Method for Resolving Names in an Electronic Messaging Environment”. This patent is incorporated herein by reference. According to this patent a message flag may be sent by the sender for follow-up operation by the recipient and it is the recipient that decides whether to record it or any follow-up action. A deadline is also set up by the recipient. For most requests, the sender has a vested interest that the recipient(s) or receiver(s) does/do the action within a specified time—the deadline. For most requests, if the sender is not satisfied that the action has taken place before a request-dependent deadline, he/she has a need to carry out a follow-up (or a reminder, or contingency action).

### SUMMARY OF THE INVENTION

In accordance with one embodiment of the present invention, the sender has at his/her disposal full automation of this whole process, via implementation of this invention as an extension of the system's software. Specifically, sender is able to automatically schedule a follow-up when composing the request.

### DESCRIPTION OF DRAWINGS

In the drawings:

FIG. 1 is a flow diagram of the sender's terminal operation according to one embodiment of the present invention.

FIG. 2 is a flow chart of the receiver's terminal operation according to one embodiment of the present invention.

### DESCRIPTION OF THE PREFERRED EMBODIMENTS OF THE PRESENT INVENTION

In accordance with the present invention, sender should be able to automatically schedule the follow-up when composing (speaking or typing) the request, because:

1. He/she is most aware of the relevance and timing of the follow-up when composing the request.

2. If the follow-up scheduling is done when composing the request, the sender has accomplished all of his/her goals which are feasible in that moment—both the request and the follow-up scheduling—in the most effective manner (end-to-end action) and in the most efficient manner (minimal time/keystrokes invested). This is particularly relevant for situations like wireless (because of the small screen, because of small/clumsy keys and because of the need for minimal keystrokes in the mobile/non-PC context) and set-top box (because of the latter two).

3. He/she is more likely to forget about the follow-up at any point in time sooner than when composing the request.

In accordance with the present invention, both when recipients of the sender's request or receiver(s) have satisfied the request before the deadline, and in cases when the receiver(s) not done so, the sender should ideally also be able to act most effectively (end-to-end action), most efficiently (minimal time/keystrokes invested), and with maximum automation provided by the system.

The system according to the present invention may be implemented using the computer hardware and program modules and additional information available in appropriate program manuals, and similar publications on Microsoft Outlook (TM) and the above cited U.S. Pat. No. 5,923,848 incorporated herein by reference. In accordance with embodiments of the invention this may also be implemented in other electronic communication systems such as cellular phone, set-top box or voice mail in addition to desktop e-mail.

Options in the paragraphs that follow can be arbitrarily combined by system builders into more or less complete automation solutions.

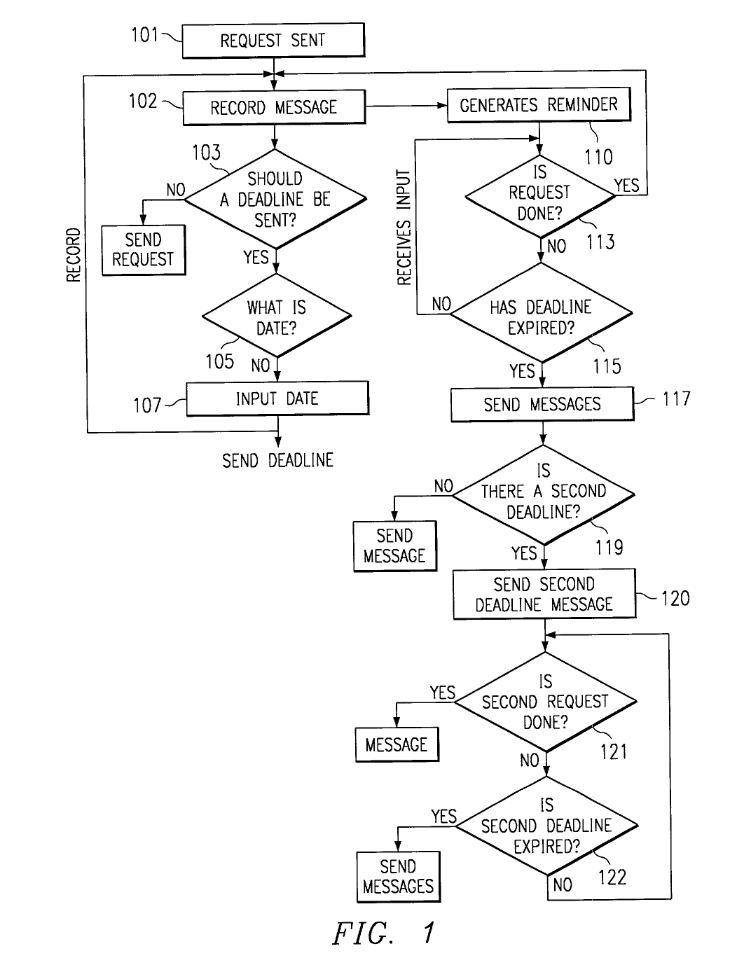

When composing a message by the sender which is a request, the system environment (GUI and/or/overloaded/function keys) provides a request deadline button. See step 101 of FIG. 1. When the request deadline button is clicked, keyed, or otherwise selected (a) the message is by default marked as a “request” and (b) if he/she wishes so, automation lets sender specify the deadline. One manner in which this may be accomplished is by choosing one of a fixed menu (for example, one hour, one day, one week, one month) or specific date/time. Another may be several different “request-deadline” buttons in the system environment can be one-click shortcuts to fixed menu choices. Sender may save his/her time by having automation apply a sender's system-wide (or per-receiver specific) default deadline to a request. In this manner, a request costs sender only one click (of the request-deadline button) more than composing any other type of message. The sender may have a record of the senders request available on the sender's screen (step 102) indicating the message was sent, the deadline and whether the action items was completed. As illustrated in FIG. 1 step 103 determines if a deadline should be added and if so steps 105 and 107 provides for the input of the date and this is recorded as items in the listing for the sender. Both the request and the deadline are sent. The system then waits for a response from the recipient.

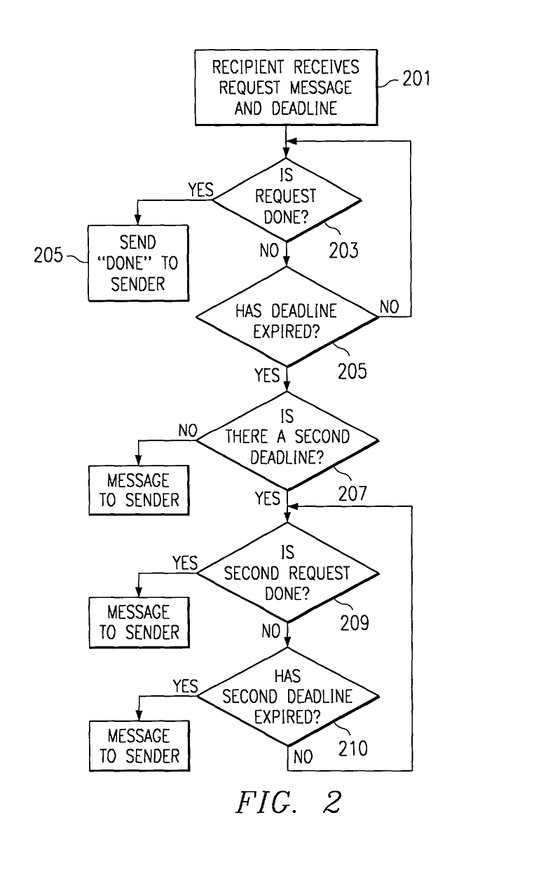

In step 201 of FIG. 2 the recipient of the sender's message receives the message with a message flag indicating a deadline. This may be as in the above cited patent. The system determines if the request has been done (step 203) and if the receiver (believes that he/she) has fulfilled the request, he/she sends the done type message such as “done” with any additional information if desired to the sender (step 205). Automation may provide a one-click done action button in the system environment for receiving (reading and/or listening to) messages.

Depending on sender's choice when composing the request, when a done message is received by sender's system (step, automation flags the request as satisfied (i.e. no further follow-up needed), and/or brings this to sender's attention, together with his/her one-click access to the pair of request/done messages.

If the deadline expires without sender's being satisfied that the request has been fulfilled, automation carries out one or more of the following:

It (system generator perhaps an output from the record) delivers to the sender a (marked as follow-up) copy of the request (or reminder, Step 110) for him/her to do (or not do if he/she is satisfied that the request has been fulfilled) any follow-up action he/she pleases. The system determines if a done message has been received (Step 113) and if yes then that is noted at the sender's terminal and record. If “no” (Step 115) determines if the deadline has expired and if not continues to wait. If the deadline has expired as determined at step 115 the following occurs.

It sends a reminder to the receiver(s), together with a copy of the original request and schedules a second follow-up. If the receiver does not satisfy the request before the second deadline (steps 119-122), automation carries out message notice to sender and recipient and recorded on the record of the sender as discussed above (steps 119-122).

At the receiver's if the request has not been done, it is determined at step 205 if the deadline has expired and if so if a second deadline has been received (step 207). If so, it then looks for the second deadline date at step 209-210 and operates as the first deadline date.

Sender may configure the system to do several (instead of one) reminder—for all or for selected (for example, his/her boss) receivers.

It asks for sender's approval before sending the reminder.

Messages of the type request, reminder, done can be visually and/or audibly marked/flagged as such when accessed individually or listed in a group. Sender may choose not to have the receiver and/or his/her system see a request or reminder flags (for example, when sender is junior to the receiver, but nevertheless his/her message is a request).

Sender may one-click accept receiver's message of type done as a satisfaction of sender's request. Alternatively, sender may reiterate the request to the receiver as not satisfied (and set a new deadline), or compose a new request.

For multiple receivers of a request, automation does steps discussed above only for those who have not satisfied the sender.

Default values exist for all choices and for all variables. System provides all initial default values. Sender can change them at any time.

At each stage in the process when sender is composing the request, when the done message has been received before the deadline, or when sender's follow-up is needed because the done this has not been the case, automation described by this invention provides both for sender's and receiver's acting in the most effective manner (end-to-end action) and in the most efficient manner (minimal time/keystrokes invested). This is particularly relevant for situations like wireless (because of the small screen, because of small/clumsy keys and because of the need for minimal keystrokes in the mobile/non-PC context) and set-top box (because of the latter two).

This solution is substantially better than, for example, tasks facility of Microsoft Outlook(TM) and similar facilities in other current systems, for one simple reason: being “one CPU”, Homo sapiens is by and large prone to view the “meat he/she needs to process” as “one input queue”, one inbox—and it is exactly the inbox (of e-mail, of voicemail) that he/she checks regularly. The follow-up reminders should be arriving there.

Also, a task has (a start and) finish date which are agreed upon between sender and receiver at the outset. For many requests (for example, from subordinate to his superior), the sender does not want to communicate either date to the receiver—but still the sender on his/her own needs to make sure that the request is satisfied before the deadline or, barring that, followed up by the sender.

In the claims:

1. In an electronic communications system, a method for automated follow-up of a request comprising the steps of:
generating a request with a deadline at a sender and recording that request;
sending that request with a deadline message to receivers;
receiving said request and deadline at the receivers;
determining at the receivers when the request is done;
and sending notice to sender when request is completed.

2. The method of claim 1 wherein said sender determines if a done request is completed before said deadline and generates a message if it has not been completed by the deadline date.

3. The method of claim 2 wherein said sender sends a message to said receivers if the deadline date has not been met.

4. The method of claim 3 wherein said sender also sends a second deadline date with said message.
